(19) United States
(12) Patent Application Publication
(10) Pub. No.: US 2004/0219272 A1
(43) Pub. Date: Nov. 4, 2004

(54) Shelf-stable sweet goods dough

(76) Inventors: Harry K. Kraklow, Eau Claire, WI (US); Cynthia R. Kandler, Chippewa Falls, WI (US)

Correspondence Address: MOORE, HANSEN & SUMNER, PLLP, 225 SOUTH SIXTH ST, MINNEAPOLIS, MN, 55402, US

(21) Appl. No.: 10/749,585

(22) Filed: Dec. 31, 2003

Related U.S. Application Data
(63) Continuation-in-part of application No. 10/189,895, filed on Jul. 3, 2002, now abandoned.
Application No. 10/189,895 is a continuation-in-part of application No. 09/946,464, filed on Sep. 6, 2001, now abandoned.
(60) Provisional application No. 60/290,396, filed on May 14, 2001.

(51) Int. Cl. A21D 10/00

(52) U.S. Cl. 426/549

(57) ABSTRACT

A shelf-stable, yeastless sweet goods dough composition and method of making same. The dough composition including a sufficient amount of flour to provide suitable structure to a finished bakery product created from the dough composition; preferably from about 10 to about 50 percent by weight of flour; a portion of the flour being wheat flour and a portion of the flour being flour selected from the group consisting of barley flour, oat flour and a mixture of the same. In alternate embodiments, beta glucans can be substituted for a portion of the flour believe to have moisture scavenging properties. The dough composition including from about 15 to about 50 percent by weight sweeteners; from about 0.5 to about 18 percent by weight eggs; from about 0.2 to about 2.0 percent by weight leavening agent; from about 5 to about 25 percent by weight fats and oils; and from about 0.5 to about 10 percent by weight emulsifying agents; wherein sufficient bound water is contained collectively in the combination of the flour, the sweeteners, the fats and oils and the eggs to provide a moisture content to the shelf-stable, yeastless sweet goods dough composition of from about 5 to about 20 percent by weight.

### CROSS-REFERENCE TO RELATED APPLICATIONS

The present application claims the benefit under 35 U.S.C. Section 119 (e) of co-pending U.S. patent application Ser. No. 10/189,895, filed Jul. 3, 2002 and now published as U.S. patent application Publication No. US 2003/0003214 A1, published Jan. 2, 2003, which is a Continuation-In-Part (CIP) of co-pending U.S. patent application Ser. No. 09/946,464, filed Sep. 6, 2001 and now published as U.S. patent application Publication No. US 2003/0008050 A1, published Jan. 9, 2003, and through each of the aforementioned co-pending applications, which claim priority thereto, U.S. Provisional Patent Application Serial No. 60/290,396, filed May 14, 2001, now expired, through each of the aforementioned co-pending applications, which claim priority thereto. Each of the aforementioned applications is hereby incorporated herein by reference.

### BACKGROUND OF THE INVENTION

1. Field of the Invention

The present invention relates to a closed cell shelf-stable sweet goods dough composition for making closed cell bakery products such as cookies, brownies, muffins and the like and, more particularly, to a shelf-stable sweet goods dough composition that remains free from component separation and microbiological growth at room temperature in an ambient atmosphere for extended periods of at least about 90, preferably about 180 days or more.

### BACKGROUND INFORMATION

Grain based bakery products, such as breads, cakes, cookies, muffins and the like have been prepared for human consumption for many years. Some type of finely ground grain is generally combined with additional ingredients, such as sweeteners, eggs, fats and oils, milk or water, etc., and the resulting dough is baked to produce a bakery product with moderate storage stability. A leavening agent or agents are generally provided to allow the finished bakery product to rise, thereby enhancing the desirability of the finished product. Generally, such dough mixtures are freshly prepared from the selected ingredients shortly before baking or perhaps prepared and then frozen, thawed or refrigerated prior to baking.

The fresh dough has limited stability and is not generally suitable for storage for even a few days at room temperature. Separation of components, such as the starch matrix (or “structure”) and the fats and oils, and microbial growth often occur over time so that these fresh dough products become undesirable and unsuited for storage.

A relatively recent development in the food industry is the preparation of dough for popular consumption of sweet bakery products, such as breads, muffins, cookies and the like, then freezing or refrigerating the dough for either frozen or refrigerated storage in the grocery store and at home prior to later use. Such frozen or refrigerated dough products are widely available to the consumer in grocery stores, but these products often command premium prices. The high cost for these frozen or refrigerated dough products is mainly linked to the cost of freezing and refrigeration during preparation, storage and distribution of the frozen or refrigerated doughs. These frozen and refrigerated doughs are specially formulated to survive either freezing and thawing or long term refrigeration, while still producing a baked food product acceptable to consumers.

Some examples of dough or batter compositions for which patents have been granted include the following.

Thulin et al. (U.S. Pat. No. 4,910,029), discloses a shelf-stable cookie dough having a plurality of textures and visually apparent flavor chips that reportedly produce cookies having characteristics of freshly baked homemade cookies. The cookie is baked from dough pieces comprising chewy cookie dough or cookie fillings enrobed in different cookie dough that provides a crispier outer shell in the finished product.

Jewell, et al. (U.S. Pat. No. 5,344,663) discloses fat substitute bakery doughs and bakery products in which an amount of potato starch is included in the dough as a substitute for fats and oils.

Lou et al. (U.S. Pat. No. 4,911,939) describes a cookie dough that is formed into individual cookie pieces and prebaked for a short period of time in order to shape the cookie and provide a gluten-containing skin on the surface of the cookie. The prebaked cookie is then packaged for microwave baking at some future time.

Weber (U.S. Pat. No. 5,171,599) discloses a low water activity refrigerated cookie dough composition that includes edible bits containing coloring agents. The dough product is substantially free of color bleed after 90 days of refrigeration. The dough composition is reported to have a water activity no greater than about 0.75.

Thulin et al. (U.S. Pat. No. 5,223,292) discloses a cookie having an extended shelf-stable soft texture. The cookies are prepared by coextruding an inner adherent cookie dough bakeable to a soft or chewy texture and an outer non-adherent cookie dough also bakeable to a soft or chewy texture. The outer non-adherent cookie dough is disclosed to contain a liquid humectant in an amount sufficient to impart a shelf-stable soft or chewy texture to the baked outer portion of the finished cookie after it is baked.

Kent et al. (U.S. Pat. No. 5,409,720) discloses a room temperature shelf-stable dough mix that includes a moist ingredient portion and a dry ingredient portion capable of being combined to produce a complete dough requiring no additional ingredients including water or any other moisture. The moist ingredient portion has a water activity level of no greater than 0.85 in order to provide the desired shelf stability. Both the moist and dry ingredient portions are preferably pre-packaged in substantially air and water impermeable containers of single batch volumes, such that the contents of the packages may be simply opened and mixed together to produce the complete dough without measuring.

Hahn (U.S. Pat. No. 6,217,929) discloses spoonable, low water activity batters.

The flour-based batter composition is spoonable at refrigeration temperature and has a refrigerated shelf life of at least about 75 days. The batter has an intermediate water activity of about 0.81 to 0.92. The batters can be baked into products such as muffins, pancakes, waffles, brownies and other foods that have a high, fluffy texture and a baked height to raw height ratio of greater than about one.

Simms et al. (European Patent Application No. 0145650) discloses a non-refrigerated shelf-stable cookie dough. The shelf-stable dough comprises about 5-20% by weight corn syrup or other viscous sweeteners, from about 10-25% sucrose, from about 13%-30% hydrogenated shortening, from about 25-60% flour, from 0-3.5% encapsulated leavening agent, from about 0-7% humectant and from about 3-25% conventional cookie texturing and flavoring ingredients. The dough has a water activity of less than about 0.72 and a pH of about 6.5 or above. The corn syrup is chosen to obtain a dough having a water activity of less than about 0.72. Suitable hard fats and shortenings employed include lard, tallow, hydrogenated animal oils and solid vegetable oils such as corn oil, peanut oil, coconut oil and soybean oil. Mixtures of fats or shortening can also be used. Antimicrobial agents such as potassium sorbate, calcium sorbate etc., can be used in amount ranging from about 0.15% to about 0.30%; typical cookie flavoring and texturizing ingredients are reported to include emulsifiers such as sorbitan and sodium stearoyl lactate. Salt, eggs, milk powder, peanut butter, vanilla, cocoa, particulate flavorings such as chocolate chips, oats, raisin and nut meats may also be included. The hard fats and shortenings, however, are believed to result in a dough that dries unnecessarily and undesirably over time, so that it becomes crumbly and can become commercially unacceptable when the bound water in the dough is not retained and separates from the structure of the dough through a drying process.

Seewi et al. (U.S. Pat. No. 5,178,893) discloses a ready-to-bake dough which is reported to be storage stable at room temperature for at least twelve months. The dough is made from a premix including flour and fat that is pre-heated under pressure to achieve desired results.

It will be appreciated, however, that many of the products made by the processes of the prior art and according to the formulations of the prior art leave room for further invention. It is particularly apparent to the present inventors, that shelf-stability is notoriously poor in doughs stored for extended periods of time at room temperature. Fats and oils and bound water begin to separate from the dough composition over time, resulting in dough compositions that either become oily on the surface as fats and oils separate from the dough structure or crumbly as the moisture content of the dough diminishes over time due to evaporation and the like. Food scientists are constantly trying to develop new emulsifiers to retain fats and oils within dough systems, new water scavengers to retain bound water within dough systems and new formulations including these emulsifiers and water scavengers to make new and better shelf-stable dough products. Thus, it is believed that there continues to be an unmet need for shelf-stable sweet dough products that can be stored at room temperature in an ambient environment in inexpensive storage facilities for an extended period of time in an ambient environment without undesirable degradation. It will be appreciated that the present invention provides advantages over the prior dough systems and the prior methods used to make such systems, and also offers other advantages over the prior art and solves other problems associated therewith.

### SUMMARY OF THE INVENTION

The present invention provides a carefully balanced, shelf-stable, yeastless sweet goods dough composition that is shelf-stable for an extended period of time at room temperature and in an ambient environment. The present invention is balanced with emulsifiers that are believed to enable fats and oils to adhere more readily to otherwise lipophobic constituents of the dough structure including bound water within structural components such as flour and within other components. The present invention also includes sufficient moisture scavenging provided either by flour made from one of two specific grains that include high levels of beta-D-glucans or a mixture of the same. These grains are oats and barley.

The combination of the emulsification and the moisture scavenging that occurs within the present shelf-stable yeastless dough composition is believed to be at least partially responsible for the long term stability of the present dough compositions. The use of sweeteners that also act as humectants is also believed to contribute to the extraordinary shelf-stability of the present yeastless dough compositions.

The shelf-stable, yeastless sweet goods dough compositions of the present invention contain sufficient retained moisture to provide a desirable dough composition for baking desirable sweet goods after at least three (3) months, even after as many as twelve (12) months of storage at room temperature in the ambient environment. A preferred yeastless dough composition of the present invention includes a structure-providing amount of flour, preferably from about 10 to about 50 weight percent of flour, the flour preferably containing at least about 10 percent by weight moisture and alternatively containing from about 8 to about 15 weight percent moisture; wherein the flour contains at least about 0.5 percent by weight flour selected from the group consisting of barley flour, oat flour and mixtures of the same and a ratio of wheat flour to flour selected from the group consisting of barley flour, oat flour and mixtures of the same, is preferably from about 1 to about 100, more preferably from about 2 to about 20, and most preferably from about 3 to about 10. The present dough further including sweeteners or sweetening ingredients including granulated sugar in an amount of from about 0 to about 40 weight percent (%) and fluid sweeteners containing from about 8 to about 40 weight percent moisture, preferably at least about 10 percent by weight moisture. The preferred dough also an amount of fats and oils or equivalent ingredients, effective to enhance the organoleptic properties of the dough, preferably from about 5 to about 25 percent by weight fats and oils, and an amount of eggs sufficient to provide body to a finished bakery product made from the preferred dough following baking, preferably from about 0.5 to about 18 percent by weight, more preferably at least about 0.5 percent by weight. An effective amount of emulsifier is provided to minimize component separation preferably at least about 0.5 percent by weight, more preferably from about 0.5 to about 10 percent by weight of the preferred yeastless dough composition. The preferred dough also includes an effective amount of a leavening agent or agents, preferably an encapsulated leavening agent, such as encapsulated sodium bicarbonate to provide the finished bakery product with a desired density, preferably at least about 0.2, more preferably from about 0.2 to about 2.0 percent by weight of the yeastless dough product; and also an effective amount of a mold inhibiting agent or agents to prevent mold growth, preferably at least about 0.1, more preferably from about 0.1 to about 1.5 percent by weight.

In alternate embodiments of the present invention, the flour from barley and/or oats can be supplemented or substituted for entirely by grain or other plant isolates, or grain or other plant extracts, high in beta glucan content. In addition, purified and/or concentrated beta glucan can be used in the present dough formulations. In further alternate embodiments the amount of beta glucan included in the shelf-stable, yeastless sweet goods dough composition of the present invention will be at least about 0.001 weight percent of beta glucan, preferably from about 0.001 to about 2.5 weight percent beta glucan, more preferably from about 0.025 to about 1.5 weight percent beta glucan, and more preferably from about 0.1 to about 1.0 weight percent beta glucan.

In preferred embodiment, the dough has a pH within a range of from about 6.5 to about 8.5, a water activity (A_{w}) of from about 0.65 to about 0.85, preferably from about 0.70 to about 0.76, more preferably of equal to or less than about 0.76, even more preferably 0.75, and is shelf-stable both at room temperature and in an ambient atmosphere or environment for extended period of storage.

Tests indicate that an A_{w} no greater than about 0.75 in the complete sweet goods dough suppresses microbial growth and, therefore, prevents spoilage of the dough composition even at room temperature and in an ambient atmosphere, thereby reducing the amount of mold inhibiting agent(s) required by regulatory and or marketing considerations. The mold inhibiting agent also assists in preventing the growth of mold during storage of the complete sweet goods dough and is effectively required in preferred embodiments by regulatory and or marketing considerations. The complete sweet goods dough composition of the present invention, with the required A_{w} no greater than about 0.75, is shelf-stable at both room temperature and in an ambient atmosphere even though the composition includes whole eggs. Tests indicate that the dough composition, according to the present invention, has a shelf life at both room temperature and in an ambient atmosphere of at least about 90 days, preferably about 120 days, more preferably about 180 days and most preferably about 210 days or more.

These and various other advantages and features of novelty that characterize the present invention are pointed out with particularity in the claims annexed hereto informing a part hereof. For a better understanding of the present invention, its advantages and other objects obtained by its use, however, reference should be made to the accompanying descriptive matter, in which there is illustrated and described preferred embodiments of the present invention.

### DESCRIPTION OF THE PREFERRED EMBODIMENTS

As noted above, various prior art bread and cookie doughs available to consumers are either frozen or require refrigeration during manufacture and storage to maintain quality. Applicants have invented a shelf-stable, yeastless sweet goods dough composition which does not require refrigeration or freezing during manufacture or storage, and exhibits stability to both separation of components and microbial growth for extended periods. Also disclosed are a method of preparation of the complete yeastless sweet goods dough compositions of the present invention that is shelf-stable at both room temperature and in an ambient atmosphere.

The complete dough compositions of the present invention that are shelf-stable at both room temperature and in an ambient atmosphere preferably have a water activity (A_{w}) no greater than about 0.76, preferably 0.75. Tests indicate that preferred dough compositions according to the present invention have a shelf life at both room temperature and in an ambient atmosphere of at least about 90 days, preferably about 120 days, more preferably about 180 days and most preferably about 210 days or more, even with whole eggs included in the dough product. As used in this disclosure, room temperature means a temperature above refrigeration temperature (40° F.) and extending up to about 110° F. As used in this disclosure, “shelf-stable” means free from component separation, dough dehydration and substantial bacterial, mold, and fungus growth at both room temperature and in an ambient atmosphere for a period of at least 90 days that would otherwise make the dough composition undesirable to a consumer of skill in the art of product purchase and consumption. As used in this disclosure, an ambient atmosphere means an atmosphere comprising generally about 78% nitrogen, 21% oxygen and 1% other gases, i.e. the normal atmosphere of the earth. As used in this disclosure, water activity or A_{w} will be defined as the ratio of vapor pressure of a solution or mixture to that of pure water at a specific temperature. Thus, A_{w} equals the equilibrium relative humidity. Water activity is a measure of the free or available water in the dough mixture. As is known in the industry, water activity may be measured by measuring the equilibrium vapor pressure of a mixture at a particular temperature and expressing that value as a ratio of the mixture equilibrium vapor pressure to the equilibrium water vapor pressure of water at that temperature.

It is believed, but not relied upon, that the A_{w} value of the present dough composition is lowered to the 0.75 value by hydrogen bonding between the sugars or other ingredient molecules of the dough and water molecules. The hydrogen bonding ties up the water molecules, preventing free movement of water molecules in the dough composition. Although the mechanism of “binding” the water molecules in the dough system is not precisely understood, this “binding” prevents the growth of microbial organisms in the dough product at both room temperature and in an ambient atmosphere for at least about 90 days and up to about 210 days or more. A mold inhibiting agent also prevents the growth of mold during storage of the complete sweet goods dough. Water binding is also effective to retain moisture within the present dough compositions to prevent premature dehydration of the dough composition prior to baking.

The sweet good dough mixture of the present invention is suitable for producing baked goods including, but not limited to, cookies, brownies, cakes, sweet breads, pie dough, muffins and the like.

As used herein “percent by weight” mean “weight percent” and vice versa. As used herein the phrase “fats and oils” means fats and/or oils. As used herein, beta glucans means beta-(1, 3)-D-glucans and beta-(1, 3)-D-glucans, preferably from cereal grains and more preferably from either oats or barley or both. As used herein, “yeastless” dough composition means a dough composition that is essentially free of yeast and does not contain an amount of active yeast effective to create any appreciable amount of leavening of the dough composition prior to baking, although inactive yeast may be present for purposes other than to provide leavening for the dough. In this regard, it will be appreciated that the dough compositions of the present invention are “closed cell” dough structures that permit gases, arising from leavening during the baking process, to pass through the respective closed cells, unlike the open cell structure found in bread doughs, wherein the open cells, created in the high protein bread dough, capture and retain leavening gases created in various phases of the bread making process.

The yeastless sweet goods dough compositions of the present invention preferably contain a flour component that contributes to the structure of the sweet goods dough, that provides at least in part the texture, taste and appearance of the final baked product. Useful flours include hard wheat flour, soft wheat flour, barley flour, rice flour, oat flour, high amylose flour, low amylose flour cake flour, hotel and restaurant (H&R) flour and the like. Cake Flour and H&R flour are well known flours used in the baking industry, and each contains wheat flour. The sweet goods dough composition of the present invention preferably contain from about 10 to about 50, more preferably from about 15 to about 40, most preferably from about 20 to about 37 weight percent flour.

For purposes of this disclosure and the accompanying claims, “sweeteners” or “sweetening agents” may include appropriate monosaccharides and disaccharides in either refined or unrefined forms, both granulated and powdered sucrose, raw sugar, turbinado sugar, brown sugar, invert sugar and the like. The sugar incorporated in the dough composition according to the present invention may also include liquid sweeteners such as fructose, dextrose, glycerol, glycerin, maltose, arabinose, sorbitol, maple syrup, corn syrup, molasses, honey, fondant, aspartame, saccharin, acesulfame K, polydextrose, sucralose, alitame, isomalt corn syrup, high fructose corn syrup, liquid sucrose and the like. The sweet goods dough compositions of the present invention preferably contain from about 15 to about 50, more preferably from about 20 to about 40, most preferably, about 25 to about 38 weight percent sweeteners. In preferred embodiments the sweeteners of the present dough compositions will include from about 0 to about 50, preferably from about 5 to about 40 weight percent of “dry” sugars having a moisture content of less than about 3 percent by weight and from about 0 to about 50, preferably from about 5 to about 45 weight percent of liquid sweeteners having a moisture content of at least about 10 percent by weight, preferably from about 15 to about 40, more preferably 35 weight percent moisture.

Fats and oils may include any suitable edible fat or fat substitute in either solid or liquid form at room temperature, including lard, tallow, butter, fish oil, whale oil and the like, and vegetable oils, such as for example, sunflower oil, safflower oil, cottonseed oil, canola oil, soybean oil, olive oil, coconut oil, palm oil and the like. As used herein, “shortening” means a “hardened” fat such as hydrogenated or partially hydrogenated vegetable oils and may also include fat substitutes including cellulose, carboxymethylcellulose (CMC), gums dextrins, maltodextrins, modified food starch, polydextrose, microparticulated protein, protein blends, lipid analogs, esterified propoxylated glycerol, sucrose polyester, and the like. Shortening is believed to have beneficial effects on the volume, grain and texture of the baked sweet goods product, as well as the texture, mouth feel and other organoleptic properties of the baked good. The sweet goods dough compositions of the present invention preferably contain from about 5 to about 25, more preferably from about 8 to about 20, and most preferably from about 10 to about 15 weight percent fats and oils.

It will be appreciated that fats and oils characteristically contain moisture. For example, vegetable oils generally contain about 20% moisture and hydrogenated and partially hydrogenated shortenings contain less than about 3 percent by weight moisture, preferably about 2 percent by weight or less.

“Emulsifiers” may include any suitable edible surfactant that increases dough stability and prevents component separation during storage and baking by having electronic charge interacting both with lipophilic substances and hydrophilic substances. Separation of components, for exampled separation of fats and oils results in a dough composition that does not bake properly and produces unacceptable finished products. Emulsifiers include without limit sodium stearoyl lactylate, sorbitan monostearate, lactylate hydrate, polysorbate 60, polysorbate 80, lecithin, propylene glycol mono- and diglycerides of fatty acids, glycerol-lacto esters of fatty acids, diacetylated tartaric esters of monoglycerides (DATEM), glycerol monostearate (GMS), ethoxylated mono- and diglycerides and the like. The yeastless sweet goods dough composition of the present invention preferably contains from about 0.5 to about 10, more preferably from about 0.75 to about 5, most preferably about 1 to about 4 weight percent of emulsifier.

The composition sweet yeastless goods dough composition of the present invention preferably includes sucrose, a fluid corn syrup/liquid sugar blend, shortening, flour, eggs, emulsifier, flavoring, encapsulated sodium bicarbonate, salt, and a mold inhibitor. Additional ingredients can include cocoa, chocolate chips/chunks, fruit pieces such as raisins, candy pieces such as gummy chunks and the like.

In a preferred embodiment of the sweet goods dough composition, the sweetener includes a mixture of white sugar and brown sugar in an about 1.72:1.00 ratio by weight, while a ratio of fluid corn syrup/liquid sugar blend to sucrose is about 1.00:2.50 by weight. In a most preferred embodiment of the yeastless sweet goods dough composition, the fluid corn syrup/liquid sugar blend is a material denoted as CFP Blend 2001, which includes 63% 36DE corn syrup, 8% High Fructose 42 and 29% liquid sucrose. Two similar blends, called CFP Blend A and CFP Blend B, contain 50% 36DE corn syrup, 10% High Fructose 42 corn syrup, 40% liquid sucrose, and 40% 36DE corn syrup, 10% High Fructose 42 corn syrup, 50% liquid sucrose, respectively. Each of the blend components is well known in the industry and commercially available. The 36DE corn syrup typically contains about 80% solids and about 20% water, the High Fructose 42 typically contains about 70% solids and about 30% water and the liquid sucrose typically contains about 68% solids and about 32% water.

In preferred embodiments of the yeastless sweet goods dough composition, the fats and oils include a mixture of solid fats and liquid oils in a ratio of about 3.0:1.0 by weight. Most preferably, the solid fats are a blend partially hydrogenated of soybean oil and cottonseed oil. A suitable solid shortening product is available from Archer Daniels Midland Co., Decatur, IL, and denoted as product code number 101-050. The liquid oil is most preferably soybean oil, well known in the food industry and available from numerous suppliers. In preferred embodiments of the sweet goods dough composition, the flour includes a mixture of bleached, enriched wheat flour such as H&R flour and a flour selected from the group consisting of barley flour, oat flour and combinations thereof, preferably barley flour in a ratio of from about 3.0:1.0 to about 10.0:1.00 by weight.

A preferred barley flour is a flour provided by Hi-Sol Ltd., a division of H.O. Short & Sons Ltd., trading as Silvery Tweed Cereals in Berwick-upon-Tweed, England, U.K., and sold under the trade name of Hi-Sol. H.O. Short & Sons Ltd have developed products from barley grain by studying varieties of barley. In particular they have examined the relationship of the starch in waxy and non-waxy varieties and the balance between the amylose and amyloprotein in blending these types. They have a specific variety or varieties of barley, which have naturally high soluble fiber levels (beta glucan levels) and have developed a growing technique which enhances these levels even further.

In milling the preferred barley flours used in preferred embodiments of the present invention, H.O. Short & Sons Ltd report that they take the following steps:

1. The grain is cleaned and conditioned.

2. The outer husk and germ are removed by polishing.

3. The resulting kernel is then cooked under pressure to stabilize the enzymes and increase the moisture to a specified level after which it is passed through a high dry heat micronizer at elevated temperature without toasting.

4. The kernel is then flaked and cooled.

5. The flake is then powdered and sifted to remove a specific amount of the starch.

6. Flour from various types of barley are then blended together to achieve products for individual uses with varying levels of beta-glucose within range of 5% to 12% by weight. These products are mixed with starch to perform as required in bakery and breakfast cereal products.

Although the amount of beta glucan in the flour can be varied, the most preferred barley flour used in the present invention is a 7% Beta Glucan Blend sold under the brand Hi-Sol 7, which contains 7% by weight beta-glucans and is used in the present invention as a moisture scavenger. This is highly effective because: (1) the starch is dry, stable and absorbent; and (2) the beta glucan is soluble, stable and is believed to act somewhat as an emulsifying agent in the presence of water and oil.

To the degree similar products can be made form oats, these products will also be usable in the present invention as oat flour. It will be appreciated that the amount of beta glucan in these various alternate scavenging agents may be increased or decreased to meet a particular formulating need. The critical parameter will be the amount of beta glucan present. Too little or too much can have negative effects on the finished product.

In Table I below, ingredients used to formulate the present yeastless dough compositions of the present invention are listed along with information about the moisture content gathered for each of the respective ingredients from their manufactures or other reliable sources.

TABLE I
Moisture Content

| INGREDIENT | % MOISTURE |
|---|---|
| Flour, H & R | 14% +/− .30% |
| Flour, Cake | 13.5 +/− .50% |
| Granulated Sugar | .05% max |
| Barley Flour aka Hisol 7 | 10.57% |
| Soy Lecithin | 1% max |
| Potassium Sorbate | not more than .01% |
| Salt | .08-.17% |
| Titanium Dioxide | .25% max |
| UltraEgg ® | 28% maximum |
| Brown Sugar | 1.0-3.0% |
| Macadamia Nuts | 2% max |
| White Confectionery Chunks | <than 1% |
| Select Raisins | 16-18% |
| Rolled Oats | 10.5% +/− 1.0 |
| Cocoa | <than 5% |
| Double-Acting Baking Powder | .2-.5% |
| Peanut Butter | 2% maximum |
| SALP (sodium aluminum | 2-.5% |
| phosphate) | |
| 36 DE Corn Syrup | 19.6-20.4% |
| 42 HFCS | 28.1-29.1% |
| Liquid Sucrose | 32.5-33.5% |

The primary function of an emulsifier is as a tenderizing agent. It is believed to improve aeration and increases the fluid carrying capacity of the dough. It also increases volume, provides a more uniform grain and smoother texture to the finished product. It also increases the number of air cells (nucleation sites) during the mixing process. A secondary function pertains to the structure of the product. It also increases the shelf life by increasing moisture retention.

In Table 11 below, the functionality of certain preferred ingredients is reported.

TABLE II
Functionality of Ingredients

| Ingredient | Function |
|---|---|
| Titanium Dioxide | Whitening agent |
| Ultra Eggs | provides structure, tenderizing and |
| | flavor. |
| Flour, H & R, Cake | provides structure and promotes |
| | drying. |
| Macadamia Nuts | a condiment, contributes to flavor. |
| Gems | a condiment, contributes to flavor. |
| Soy Lecithin | a surface active agent with unique |
| | properties. It can modify the boundary |
| | layers between many types of |
| | substances. When used between |
| | solid phases, lecithin acts as a |
| | lubricant or release agent. When used |
| | between solid and liquid phases |
| | lecithin acts as a dispersing agent. In |
| | the presence of two immiscible phases |
| | lecithin reduces the surface tension |
| | and acts as an emulsifier. Acts as a |
| | tenderizing agent and contributes to |
| | the structure. |
| White Confectionery Chunks | a condiment, contributes to flavor. |
| Select raisins | a condiment, contributes to flavor. |
| Rolled Oats | promotes drying. |
| Light Brown Sugar | provides tenderizing, contributes to |
| | flavor. |
| Peanut Butter | contributes to flavor. |
| Cocoa | contributes to flavor, promotes drying. |
| Hi-Sol 7/Barley Flour | moisture scavenger, stabilizer, |
| | promotes drying. |
| Salt | contributes to flavor. |
| Granulated Sugar | tenderizing agent, contributes to |
| | flavor. |
| Double-Acting Baking Powder | chemical leavening system, promotes |
| | tenderizing. |
| Encapsulated Sodium | chemical leavening agent. |
| Bicarbonate | |
| Lactylate Hydrate | provides tenderizing properties and |
| | structure. It is a soft plastic blend of |
| | ethoxylated monglycerides and sodium |
| | stearol lactylate that is fully hydrated to |
| | maximize functionality. It increases |
| | volume, machinability, dough |
| | tolerance, softness, and shelf-life. |
| Vanilla | contributes to flavor. |
| Potassium Sorbate | helps to control mold growth, mold |
| | inhibitor. |
| Liquid Sweetener Blends | contributes to tenderizing, flavor and |
| (36 DE, 42 HFCS, | moistening. |
| Liquid Sucrose) - contributes to | |
| Hydrogenated Shortening | contributes to structure, tenderizing. |
| | Excessive use promotes drying. |
| Soybean Oil | tenderizing agent. |
| SALP(sodium aluminum | chemical leavening agent, promotes |
| phosphate) | tenderizing. |

The eggs utilized for the preferred embodiments of present dough composition are commercially available whole eggs which are preserved. In a preferred embodiment of the sweet goods dough composition, the eggs are a preserved whole egg product known as UltraEgg® preserved eggs, which are widely used in the food industry and available from Cutler Egg Products, Inc., Abbeville, Ala. The preserved egg product, which is a preserved aqueous fluid, containing equal amounts of whole eggs and granulated sugar (sucrose) as a preservative and is reported by its makers to be free of Salmonella, Listeria, Staph and E. Coli. The UltraEgg® preserved egg product is reported to contain a minimum of 72% solids and a maximum of 28% moisture. The preserved egg product is reported to be stable to microbial and mycotic degradation at room temperature for at least about six months. The preserved egg product is preferably present in the sweet goods dough at from about 0.5 to about 18, preferably from about 4 to about 17, more preferably from about 8 to about 15 and most preferably from about 10 to about 14 weight percent. The eggs provide body to the sweet goods dough both in the unbaked and baked condition.

Although the UltraEgg® preserved egg product is preferred, it will be appreciated that the present invention can also be made with whole eggs, frozen whole eggs, dried whole eggs, liquid whole eggs, a combination of dried egg yolks and dried egg whites or egg albumin, a combination of any of the aforementioned products and the like. It will be appreciated, however, that in substituting these other egg products for the preferred preserved eggs, formulating strategies will shift because these other products contain less sugar (approximately 50% by weight in the UltraEgg®) and in certain circumstances contain either less or more moisture. As discussed above, moisture content is particular importance in the present sweet goods dough composition, so the use of these products will generally require formulation choices that balance the moisture level and balance the amount of added sweeteners, which are generally humectants as well and often have significant amounts of moisture content primarily incorporated as bound water.

A preferred emulsifier of the yeastless sweet goods dough of the present invention is a mixture of lactylate hydrate and lecithin in a ratio of about 3.0:1.0 by weight. Lactylate hydrate is composed of sodium stearol lactylate, ethoxylated monoglycerides, polysorbate 60 and propionic acid is available from Custom Ingredients, Inc., New Braunfels, Tex., under the name Lactylate hydrate. Lecithin is well known in the food industry and available from numerous suppliers, including Archer Daniels Midland Co., Decatur Ill.

In a preferred embodiment of the yeastless sweet goods dough composition, the flavoring preferably includes a mixture of clear artificial vanilla flavoring and a butter/vanilla/lemon flavoring in a ratio of about 2.0:1.0 by weight to improve the flavor of the sweet goods dough. The flavoring is preferably present in the sweet goods dough at about 1.0 to about 1.7 weight percent.

An encapsulated sodium bicarbonate is employed in preferred embodiments of the present yeastless sweet goods dough composition. Sodium bicarbonate, encapsulated with a solid shortening having a melting point of about 150 to about 158° F., is well known in the food industry and commercially available from numerous sources. Encapsulating sodium bicarbonate in a solid shortening prevents reaction of the sodium bicarbonate with water or other dough components during storage at both room temperature and in an ambient atmosphere. Only upon baking the preferred sweet goods dough, does the encapsulated sodium bicarbonate become available to produce leavening of the finished product. The encapsulated sodium bicarbonate (50% Na₂ (CO₃)₂) is present in preferred sweet goods dough compositions in an amount of from about 0.25 to about 2.0 weight percent, preferably from about 0.5 to about 1.5 weight percent and, most preferably, from about 0.9 to about 1.2 weight percent.

Preferred embodiments of the yeastless sweet goods dough composition of the present invention include about 0.5% salt by weight, to improve taste of the sweet goods dough, and a mold inhibitor in an amount effective in preventing molding of the sweet goods dough during prolonged storage at room temperature and in an ambient atmosphere. Preferably, the mold inhibitor is present in the sweet goods dough in an amount of from about 0.05 to about 1.0 weight percent and, more preferably, from about 0.1 to about 0.8 weight percent. Most preferably, the mold inhibitor is potassium sorbate present at from about 0.4 to about 0.8% by weight in preferred dough compositions. Potassium sorbate is widely known in the food industry and readily available from suppliers. Other antimycotic agents which inhibit the growth of undesirable yeasts and/or molds in the dough composition include salts of acetic acid, salts of propionic acid, salts of lactic acid, salts of citric acid, calcium phosphate and the like. These agents are generally present in alternate dough compositions at about 0.1 to 0.2% by weight. Too little mold inhibitor will not provide sufficient antimycotic effect, while too much can impart an off taste to the dough product.

The above compositions of the sweet goods dough invention provide a basic sweet goods dough product that is stable at both room temperature and in an ambient atmosphere for at least about 90 days, preferably about 120 days, more preferably about 180 days and most preferably about 210 days or more. This basic dough can be supplemented with additional edible particulate substances, including chocolate chips, white and dark chocolate chunks, various candy bits, oatmeal, raisins and the like, to produce a similar complete sweet goods dough, shelf-stable at both room temperature and in an ambient atmosphere, containing any of the additional edible particulates mentioned above and/or any other similar particulate materials that are known in the art.

Also included in the present invention is a preferred process for preparing the complete room temperature, ambient atmosphere, shelf-stable sweet goods dough compositions. A commercial mixing machine is employed to mix the ingredients in a single container. Suitable mixing machines are available from numerous manufacturers and are well known in the industry. Since the process for preparing the sweet goods dough composition of the present invention involves sequential steps, the sweet goods dough is preferably prepared by a batch process. The process includes the steps of first mixing together, also termed “creaming”, the selected amounts of sugar, fluid corn syrup/sugar blend, shortening, eggs, emulsifier, flavoring, salt and mold inhibitor in the mixer to form a first creamed slurry. The duration of mixing is well known to those skilled in the art and varies depending upon the particular dough mixture. The “creaming” step duration varies with the mixing machine used and continues until the first creamed slurry exhibits a color similar to a yellow cake batter in the case of cookie dough. Next, the selected amount of flour, plus sodium carbonate in the case of oatmeal/raisin cookies, is added to and mixed with the first creamed slurry to produce a first dough mixture. Lastly, a selected amount of encapsulated sodium bicarbonate is added and mixed with the first dough mixture to produce a final dough product with a water activity less than about 0.75 and a pH with a range from about 6.5 to about 8.5.

Additional edible particulates, including chocolate chips, white and dark chocolate chunks, various candy bits, or oatmeal and raisins, are mixed into the final dough product to produce a sweet goods dough having the edible particulates distributed therein. The final dough product is transferred to a suitable container that can be sealed for storage of the dough product at both room temperature and in an ambient atmosphere for at least about 90 days, preferably about 120 days, more preferably about 180 days and most preferably about 210 days or more, without separation of components and without microbial growth.

The process preferred for preparing the sweet goods dough compositions of the present invention is carried out in an ambient atmosphere at temperatures in the range from of about 60° to about 100° F., in accordance with good manufacturing practices (GMP). The machinery and utensils used in preparing the sweet goods dough compositions require no special sterilization or other anti-mycotic treatment beyond being clean and dry, as is used with any food goods preparation equipment according to Good Manufacturing Practices (GMP).

A preferred sweet goods dough composition of the present invention, prepared by a batch process in a commercial mixing machine, results in a viscous dough mixture. Commercial machines fitted with augers or pistons for transferring and packaging dough are commonly employed in the industry. One machine suitable for transferring and packaging of the viscous sweet goods dough mixture is a VEMAG filler, the Robot 500, having a dough reservoir and a double screw auger, available from Robert Reiser and Co., Inc., Canton, Mass. The standard auger used with the VEMAG filler, designed for handling meat products, resulted in damage to the edible particulates passing through the machine, with the broken edible particulates discoloring the sweet goods dough, due to coloration bleeding from the damaged edible particulates into the dough. To enable the machine to properly move the viscous sweet goods dough mixture through it without damage to the edible particulates, the VEMAG filler standard auger was replaced with a 72 String Cheese 367 double screw auger, part number 912380040. The VEMAG machine, fitted with this double screw auger, provides facile transferring of the viscous, sweet goods dough mixture, without damage to the edible particulates, and mechanized filling of dough containers suitable for sale and use by institutions and consumers. Alternatively, the sweet good dough cylinders extruded by the dough handling machine may be cut into uniform pieces (cookie size or muffin size), which are placed on paper sheets and the dough-containing paper sheets stacked in a cardboard carton for distribution.

Other machines suitable for transferring and packaging the viscous, sweet good dough mixture are Marlen dough pumps, available from Marlen Research Corporation, Overland Park, KS. Marlen dough pumps, such as Models 629 or 670, operate with twin pistons that provide a precise metered flow of sweet goods dough without pulsation. The pistons readily transfer the viscous, sweet- good dough mixture without damage to the edible particulates distributed therein.

The containers for the sweet goods dough mixture need not be oxygen impervious or air tight. Simple plastic containers with friction fit lids are sufficient. Should the container integrity be compromised by, for example, a puncture, the sweet goods dough mixture maintains its shelf stability for at least about 90 days, preferably about 120 days, more preferably about 180 days and most preferably about 210 days or more. Should the dough container cover be inadvertently left open, the dough mixture may dry to a limited extent, but the dough mixture is still likely to maintain its shelf stability and bakeability for at least about 90 days, preferably about 120 days, more preferably about 180 days and most preferably about 210 days or more.

To assess shelf-stability, the yeastless sweet dough compositions of the present invention are tested in four tests designed to evaluate shelf-stability. Samples of the respective dough compositions are stored at room temperature in an ambient environment for extended periods of time. Samples are tested after initial processing. Samples are then tested after 90, 120, 180, and 210 days of storage.

The four tests are tests for (1) moisture loss; (2) bakeability; (3) mold growth; and (4) component separation. Moisture loss is measured by comparing the amount of moisture in a stored sample to the amount of moisture in a sample tested after initial preparation. The samples are tested by weighing the sample, then cooking the sample in a microwave until the sample is blackened and the moisture is all driven off. The sample is then weighed again, and the difference between the weight of the sample prior to cooking and after cooking is reported as the amount of moisture in the sample. The amount of moisture in the samples of the stored dough is compared to the amount of moisture reported for the same dough when it was tested after initial preparation. The difference is reported to be the amount of moisture loss during storage. Sample sizes are 1.3 ounces.

Bakeability is measured by comparing the flow and rise of a 1.3 ounce sample tested after initial preparation of the dough. Flow and rise are measured after cooking a 1.3 ounce sample on an aluminum alloy cookie sheet in a 450° F. oven for 10-13 minutes. In the tests of the samples reported below, the cookies are standardized so that a 1.3 ounce sample, after initial preparation, will flow outward on the cookie sheet during baking to a diameter of 3″, from a prebaked diameter of 2′. The sample will rise to a height of ⅜′. After baking and measuring the stored samples, the flow and rise of the stored samples is compared to that of the initially prepared samples which all fit the standardized flow and rise for the standardized cookie doughs of 3″ and ⅜″, respectively.

Mold growth and component separation are measured by simple observation and comparison to observations of the samples of initially prepared dough. Mold growth is generally not present, but the observer is a person familiar with the appearance of mold growth. Component separation generally appears as a beading of oil on the surface of a stored sample of dough. In this case the dough is also observed by an individual who is familiar with the appearance of such component separation.

Alternate dough compositions disclosed in the following Examples (1-4) were formulated according to the steps set forth in the preferred process disclosed above to discover the most suitable embodiments of the present invention and to illustrate the broad scope of the present invention. In Examples 1-4 below, the fluid corn syrup/sugar blend to sucrose ratio was about 1.0:2.5 by weight, the solid to liquid shortening ratio was 3.0:1.0 by weight, and the emulsifiers, lactylate hydrate and lecithin, were present in a ratio of about 3.0:1.0 by weight. The eggs were UltraEgg preserved eggs, a preserved whole egg fluid material containing about 50 wt-% sugar, with a whole egg to sugar ratio of 1.0:1.0.

### EXAMPLE 1

A sugar cookie dough composition having 20.60% sucrose, 8.22% fluid corn syrup/sugar blend, 14.57% shortening, 36.47% flour, 13.61% preserved eggs, 3.21% emulsifier, 1.53% flavoring,1.17% encapsulated sodium bicarbonate,0.51% salt, and 0.10% mold inhibitor, all measured by weight, was made, and the ingredients combined according to the preferred method outlined above. The A_{w} value for the final sweet goods dough product composition was 0.76, and the pH value was 8.17.

### EXAMPLE 2

A chocolate chip cookie dough composition having 18.34% sucrose, 7.32% fluid corn syrup/sugar blend, 12.97% shortening, 32.47% flour, 12.12% preserved eggs, 2.85% emulsifier, 1.36% flavoring, 1.04% encapsulated sodium bicarbonate, 0.46% salt, 0.09% mold inhibitor, and 10.98% chocolate chips, all measured by weight, was made, and the ingredients combined according to the preferred method outlined above. The A_{w} value for the final sweet goods dough product composition was 0.757 and the pH value was 8.17.

### EXAMPLE 3

An oatmeal/raisin cookie dough composition having 15.44% sucrose, 6.16% fluid corn syrup/sugar blend, 10.90% shortening, 24.64% flour, 10.20% preserved eggs, 2.40% emulsifier, 1.10% flavoring, 1.16% baking powder, 0.78% encapsulated sodium bicarbonate, 0.38% salt, 0.08% mold inhibitor, 7.51% rolled oats, and 19.25% raisins, all measured by weight, was made, and the ingredients combined according to the preferred method outlined above. Baking powder was mixed with the flour and the resulting mixture was added to and mixed with the first creamed slurry. The A_{w} value for the final sweet goods dough product composition was 0.719 and the pH value was 8.04.

### EXAMPLE 4

A double chocolate cookie dough composition having 17.31% sucrose, 6.90% fluid corn syrup/sugar blend, 12.05% shortening, 30.20% flour, 11.43% preserved eggs, 2.69% emulsifier, 1.28% flavoring, 0.97% encapsulated sodium bicarbonate, 0.43% salt, 0.086% mold inhibitor, 5.18% white chocolate chunks, 10.36% chocolate chunks, and 1.12% cocoa, all measured by weight, was made, and the ingredients were combined according to the preferred method outlined above. The cocoa was added with the first group of ingredients to produce the first creamed slurry. The A_{w} value for the final sweet goods dough product composition was 0.754 and the pH value was 7.47.

In the early development of the present sweet goods dough composition, five similar cookie dough compositions, sugar, chocolate chip, candy bits, double chocolate, and oatmeal/raisin were each analyzed for A_{w} and pH in triplicate. The A_{w} value determinations ranged from 0.711 to 0.768 and, depending on the particular variety, the A_{w} values averaged from 0.718 to 0.765. Similarly, the pH value determinations ranged from 6.53 to 7.39 and, depending on the particular variety, the pH averaged from 6.55 to 7.33.

Each of these cookie dough compositions and each of the cookie dough compositions in Examples 1-4 were believed to be good products initially, but after a relatively short period of time, several of these doughs exhibited unacceptable component separation requiring further formulation to eliminate this problem. There was no mold growth, moisture loss was negligible, and bakeability showed no difference after 90, 120, 180, and 210 days, except that flow was reduced by ⅛″ and height was increased by 1/16″ after 210 days.

In addition to the four cookie dough compositions described in Examples 1-4, a shelf-stable brownie dough composition is also described in Example 5 below.

### EXAMPLE 5

A chocolate brownie dough composition having 21.67% sucrose, 18.97% fluid corn syrup/sugar blend, 12.46% shortening, 26.01% flour, 10.84% preserved eggs, 1.56% emulsifier, 1.46% flavoring, 0.52% encapsulated sodium bicarbonate, 0.52% sodium aluminum phosphate, 0.26% salt, 0.52% mold inhibitor, and 5.20% cocoa, all measured by weight, was made. In this example, the fluid corn syrup/sugar blend to sucrose ratio was 1.0:1.5 by weight, the shortening was all liquid shortening, and the emulsifier was all lactylate hydrate. The eggs were a preserved whole egg fluid material containing about 50 wt-% sugar, with a whole egg to sugar ratio of 1.0:1.0. The ingredients were combined according to the preferred method outlined below. The A_{w} value for the final sweet goods dough product composition was 0.73 and the pH value was 6.58. There was no mold growth, moisture loss was negligible, and bakeability showed no difference after 90, 120,180, and 210 days, except that flow was reduced by ⅛″ and height was increased by 1/16″ after 210 days. This dough product also exhibited unacceptable component separation overtime, however, and new formulations were developed.

Also included in the present invention is a process for preparing room temperature, ambient atmosphere, shelf-stable brownie dough compositions. Since the process for preparing the brownie dough composition of the present invention involves sequential steps, the brownie dough is prepared by a batch process. A commercial mixing machine is employed to mix the ingredients in a single container. The process includes the steps of first mixing together all dry ingredients for four minutes. Next, the selected amount of wet ingredients is added to and mixed with the blended dry ingredients to produce a brownie dough mixture with a water activity less than about 0.75 and a pH with a range from about 6.5 to about 8.5.

Additional edible particulates, including chocolate chips, white and dark chocolate chunks, or various candy bits, are mixed into the brownie dough product to produce a brownie dough having the edible particulates distributed therein. Again, due to the viscous nature of the brownie dough, a VEMAG Robot 500, fitted with the 72 String Cheese 367 double screw auger, or a Marlen Model 629 or 670, is used for transferring and packing the brownie dough. The brownie dough product is transferred to a suitable container that can be sealed for storage of the brownie dough product at both room temperature and in an ambient atmosphere for at least about 90 days, and up to 210 days or more, without observable separation of components and without measurable microbial growth. The containers for the brownie dough need not be oxygen impervious or air tight. Simple plastic containers with friction fit lids are sufficient, as discussed in detail above.

Federal regulations, known as the Licensed Acid Canned Food regulations (LACF), require a food product to have an A_{w} no more that 0.85 and a pH not to exceed 4.6 for designating the product as “shelf-stable.” It was believed, prior to this invention, that an acidic pH of 4.6 or less was required to inhibit microbiological growth in a sweet dough. The inventors have confirmed through independent laboratory testing that the sweet goods dough compositions of the present invention are “shelf-stable” at room temperature and in an ambient atmosphere for a period of at least about 120 days and up to about 210 days. Based upon the test results, it is believed that the sweet goods dough compositions of the present invention are exempt from the LACF regulations and can be designated as “shelf-stable” sweet goods dough.

In each of the example compositions above, the A_{w} is less than about 0.75. Surprisingly, the pH for each of the example compositions is close to neutral or slightly basic. It had previously been believed that an acidic pH was required to inhibit microbiological growth. The pH of the example cookie dough compositions ranges from 7.47 to 8.17, while the example brownie dough has a pH of 6.58. Thus, the novel dough composition of the present invention is shelf-stable with a low water activity, A_{w} less than about 0.75, and with a near neutral or basic pH with a range from about 6.5 to about 8.5.

In each of the above examples, the A_{w} value is no greater than about 0.75, which indicates that each of the resulting dough compositions is resistant to microbial degradation when stored at both room temperature and in an ambient atmosphere for a period of at least about 120 days. To confirm the stability of the dough composition to microbial and mycotic degradation, microbial and mycotic assays were performed on the dough composition of Example 2 above over a period of 120 days storage at room temperature and in an ambient atmosphere. Samples of dough were placed in clean, sealed containers held at room temperature and in an ambient atmosphere, with assays performed on a previously unopened sample at days 30, 60, 90 and 120. Samples were analyzed for the bacteria Bacillus Cereus, Enterobacteriaceae, Clostridium Perfringens, Coliforms, E. Coli, Listeria, Psychrotrophs, Salmonella, Shigella, Staphylococcus, and Yersinia, as well as a Standard Plate Count (S.P.C.), an Anaerobic Plate Count (A.P.C.), a Yeast Count and a Mold Count. The assay results are presented in Table 1 below where colony forming units/gram (CFU/G) are the units of measure. No significant bacterial, yeast or mold growth was detected over the 120 day test period.

TABLE III

| | All Bacteria | S.P.C. (Est.) | A.P.C. (Est.) | Yeast | Mold |
|---|---|---|---|---|---|
| Day 30 | Negative | 240 CFU/G | <10 CFU/G | <10 CFU/G | 90 CFU/G |
| Day 60 | Negative | 120 CFU/G | <10 CFU/G | <10 CFU/G | 25 CFU/G |
| Day 90 | Negative | 300 CFU/G | <10 CFU/G | <10 CFU/G | 190 CFU/G |
| Day 120 | Negative | 80 CFU/G | <10 CFU/G | <10 CFU/G | 15 CFU/G |

The sweet goods dough of the present invention provides numerous advantages including, but not limited to, the following:

1) Shelf stability, including stability against microbiological growth and component separation at both room temperature and in an ambient atmosphere for at least about 90 days, and up to 210 days or more.

2) Refrigeration costs during transportation and storage of the sweet goods dough are eliminated. p1 3) Baking time is reduced versus refrigerated or frozen dough since the dough of the present invention is used at room temperature.

4) In the case of cookies made from the sweet goods dough, the baked product remains moist, pliable and palatable for up to two weeks after baking.

5) Manufacturing costs are minimized since no extra sterilization precautions are required and cooling equipment is not needed.

The present invention also encompasses each of the following embodiments presented in Examples 6-16 below.

### EXAMPLES 6-8

Shelf-Stable Sugar Cookie Dough, Shelf-Stable Snickerdoodle Dough and Shelf-Stable Chocolate Chip Cookie Dough were each prepared according to the respective formulations listed below and according to the preferred method described in the text above. The dough compositions each contain a substantial amount of barley flour. The barley flour was Hi-Sol 7 from Hi-Sol Ltd., a division of H.O. Short and Sons Ltd., Berwick-upon-Tweed, England. Long term shelf stability studies were conducted and the respective doughs did not exhibit any component separation after 90, 120, 180, and 210 days. There was no mold growth, moisture loss was negligible, and bakeability showed no difference after 90, 120, 180, and 210 days, except that flow was reduced by ⅛″ and height was increased by 1/16″ after 210 days.

TABLE IV

| | Example 6 | | Example 8 |
|---|---|---|---|
| | SUGAR | Example 7 | CHOCOLATE |
| Ingredient | COOKIE | SNICKERDOODLE | CHIP |
| Hotel and Restaurant (H&R) Flour | 33.25% | 33.10% | 26.44 |
| BARLEY FLOUR | 4.62% | 4.60% | 3.17% |
| GRANULATED SUGAR | 20.51% | 20.41% | 5.32% |
| BROWN SUGAR | | | 11.00% |
| Corn Syrup(CFP BLEND 2001) | 4.62% | 4.60% | 11.92% |
| LIQUID SUCROSE | 8.31% | 8.28% | |
| Eggs (ULTRA EGGS) | 9.70% | 9.66% | 10.18% |
| HYDROGENATED SHORTENING | 7.39% | 7.36% | 7.96% |
| SOYBEAN OIL | 3.33% | 3.31% | 3.70% |
| LACTYLATE HYDRATE | 2.40% | 2.39% | 1.06% |
| SOY LECITHIN | 0.92% | 0.92% | 0.53% |
| VANILLA | 2.31% | 2.30% | 0.73% |
| Encap. SODIUM BICARB (50%) | 1.16% | 1.16% | 0.93% |
| POTASSIUM SORBATE | 0.69% | 0.69% | 0.53% |
| SALT | 0.46% | 0.46% | 0.41% |
| CINNAMON | | 0.44% | |
| TITANIUM DIOXIDE | 0.24% | 0.23% | |
| LIQUID BUTTER FLAVORING | 0.09% | 0.09% | 0.26% |
| CHOCOLATE CHIPS | | | 15.86% |

### EXAMPLES 9-11

Shelf-Stable Candy Cookie Dough, Shelf-Stable White Chocolate Macadamia Nut Cookie Dough and Shelf-Stable Double Chocolate Chunk Cookie Dough were each prepared according to the respective formulations listed below and according to the preferred method described in the text above. The dough compositions each contain a substantial amount of barley flour. The barley flour was Hi-Sol 7 from Hi-Sol Ltd., a division of H.O. Short & Sons Ltd., Berwick-upon-Tweed, England. Long term shelf stability studies were conducted and the respective doughs did not exhibit any component separation after 90, 120, 180, and 210 days. There was no mold growth, moisture loss was negligible, and bakeability showed no difference after 90, 120, 180, and 210 days, except that flow was reduced by ⅛″ and height was increased by 1/16″ after 210 days.

TABLE V

| | | Example 10 | Example |
|---|---|---|---|
| | | White | 11 |
| | Example 9 | Chocolate | Double |
| | Candy | Macadamia | Chocolate |
| Ingredient | Cookie | Nut | Chunk |
| Hotel and Restaurant (H&R) Flour | 26.44% | 25.43% | 24.77% |
| BARLEY FLOUR | 3.17% | 3.05% | 2.97% |
| GRANULATED SUGAR | 5.32% | 5.12% | 4.99% |
| BROWN SUGAR | 11.00% | 10.57% | 10.57% |
| Corn Syrup(CFP BLEND 2001) | 11.92% | 11.47% | 11.17% |
| Eggs (ULTRA EGGS) | 10.18% | 9.79% | 9.70% |
| HYDROGENATED | 7.96% | 7.66% | 7.63% |
| SHORTENING | | | |
| SOYBEAN OIL | 3.70% | 3.56% | 3.47% |
| LACTYLATE HYDRATE | 1.06% | 1.02% | 1.00% |
| SOY LECITHIN | 0.53% | 0.51% | 0.50% |
| VANILLA | 0.73% | 0.70% | 0.68% |
| Encapsulated SODIUM BICARB. | 0.93% | 0.89% | 0.87% |
| (50%) | | | |
| POTASSIUM SORBATE | 0.53% | 0.51% | 0.50% |
| SALT | 0.41% | 0.39% | 0.39% |
| LIQUID BUTTER FLAVORING | 0.26% | 0.25% | 0.25% |
| CHOCOLATE CHIPS | | | 9.90% |
| GEMS | 15.86% | | |
| WHITE CHOCOLATE CHUNKS | | 12.72% | 9.90% |
| MACADAMIA NUTS | | 6.36% | |
| COCOA | | | 0.74% |

### EXAMPLES 12-13

Shelf-Stable Oatmeal Raisin Cookie Dough and Shelf-Stable Brownie Dough were each prepared according to the respective formulations listed below and according to the preferred method described in the text above. The dough compositions each contain a substantial amount of barley flour. The barley flour was Hi-Sol 7 from Hi-Sol Ltd., a division of H.O. Short & Sons Ltd., Berwick-upon-Tweed, England. Long term shelf stability studies were conducted and the respective doughs did not exhibit any component separation after 90, 120, 180, and 210 days. There was no mold growth, moisture loss was negligible, and bakeability showed no difference after 90, 120, 180, and 210 days, except that flow was reduced by ⅛″ and height was increased by 1/16″ after 210 days.

TABLE VI

| | Example 12 | |
|---|---|---|
| | OATMEAL | Example 13 |
| Ingredient | RAISIN | BROWNIE |
| Hotel and Restaurant (H&R) Flour | 23.12% | 19.51% |
| BARLEY FLOUR | 2.77% | 6.50% |
| GRANULATED SUGAR | 4.65% | 21.68% |
| BROWN SUGAR | 9.61% | |
| Corn Syrup (CFP BLEND 2001) | 11.35% | 18.97% |
| Eggs (ULTRA EGGS) | 8.90% | 10.84% |
| HYDROGENATED SHORTENING | 8.49% | |
| SOYBEAN OIL | 3.70% | 12.46% |
| LACTYLATE HYDRATE | 0.92% | 1.56% |
| SOY LECITHIN | 0.46% | |
| VANILLA | 0.64% | 1.46% |
| Encapsulated SODIUM BICARB. | 0.81% | 0.52% |
| (50%) | | |
| DOUBLE-ACTING BAKING POWDER | 0.35% | |
| SODIUM ALUMINUM PHOSPHATE | | 0.52% |
| POTASSIUM SORBATE | 0.46% | 0.52% |
| SALT | 0.42% | 0.26% |
| LIQUID BUTTER FLAVORING | 0.23% | |
| COCOA | | 5.20% |
| RAISINS | 15.03% | |
| ROLLED OATS | 8.09% | |

### EXAMPLES 14-15

Shelf-Stable Peanut Butter Cookie Dough I and Shelf-Stable Peanut Butter Cookie Dough II were each prepared according to the preferred method described in the text above and according to the formulations set forth below. The barley flour was Hi-Sol 7, described above and the Peanut Butter was Houston Brand Stabilized Chunky Peanut Butter from Peanut Processors, Inc., Sherman, Texas. The Stabilized Peanut Butter contains 90% peanut solids and peanut oil; 7% sugar (sucrose); 1.75% Tri-Blend oil stabilizer made up of equal parts of cottonseed oil, rape seed oil and soybean oil; and 1.25% salt. Both products were free of mycotic growth after 90, 120, 180, and 210 days. Differences in moisture and bakeability were negligible after each of those storage periods, but only Peanut Butter Cookie Dough II was without component separation at 180 and 210 days.

TABLE VII

| | Example 14 | Example 15 |
|---|---|---|
| | PEANUT | PEANUT |
| Ingredient | BUTTER I | BUTTER II |
| Hotel and Restaurant (H&R) Flour | 21.14% | 10.94% |
| Cake Flour | | 10.94% |
| BARLEY FLOUR | | 0.66% |
| GRANULATED SUGAR | 15.33% | 14.22% |
| BROWN SUGAR | 12.31% | 10.94% |
| Corn Syrup(CFP BLEND 2001) | 11.63% | |
| Eggs (ULTRA EGGS) | 3.02% | 4.38% |
| HYDROGENATED SHORTENING | 14.16% | 14.22% |
| SOYBEAN OIL | 2.42% | 2.19% |
| VANILLA | | 0.66% |
| Encapsulated SODIUM BICARB. (50%) | 0.63% | 0.55% |
| POTASSIUM SORBATE | 0.42% | 0.44% |
| SALT | 0.60% | 0.38% |
| PEANUT BUTTER | 18.34% | 16.41% |
| SODIUM ALUMINUM PHOSPHATE | | 0.16% |
| (SALP) | | |

### EXAMPLES 16-17

Shelf-Stable Muffin Base and Shelf-Stable Cornmeal Muffin were each prepared according to the respective formulations listed below and according to the preferred method described in the text above. The dough compositions each contain a substantial amount of barley flour. The barley flour was Hi-Sol 7 from Hi-Sol Ltd., a division of H.O. Short & Sons Ltd., Berwick-upon-Tweed, England. Long term shelf stability studies were conducted and the respective doughs did not exhibit any component separation after 90, 120, 180, and 210 days. There was no mold growth, moisture loss was negligible, and bakeability showed no difference after 90, 120, 180, and 210 days, except that flow was reduced by ⅛″ and height was increased by 1/16″ after 210 days.

TABLE VIII

| | Example 16 | Example 17 |
|---|---|---|
| Ingredient | MUFFIN BASE | CORNMEAL MUFFIN |
| Hotel and Restaurant (H&R) Flour | 36.45% | 29.07% |
| BARLEY FLOUR | 3.65% | 5.04% |
| Corn Syrup(CFP BLEND 2001) | 10.94% | 14.34% |
| LIQUID SUCROSE | 13.42% | |
| Eggs (ULTRA EGGS) | 16.40% | 15.50% |
| HYDROGENATED SHORTENING | 14.58% | 7.75% |
| SOYBEAN OIL | | 11.63% |
| VANILLA | 0.55% | 0.39% |
| Encapsulated SODIUM BICARB. (50%) | 1.09% | 1.94% |
| POTASSIUM SORBATE | 0.73% | 0.77% |
| SALT | 0.73% | 0.39% |
| SODIUM ALUMINUM PHOSPHATE | 1.46% | 1.16% |
| NONFAT DRY MILK | | 1.55% |
| DOUGH STRENGTHENER | | 0.77% |
| CORNMEAL (WHITE OR YELLOW) | | 9.70% |

TABLE IX
Wheat Flour to Barley Flour Ratio; Dry
Sweetener to Fluid Sweetener Ratio

| | | Dry Sweetener/ |
|---|---|---|
| | Wheat Flour/Barley | Liquid |
| SHELF-STABLE DOUGHS | Flour Ratio | Sweetener Ratio |
| SUGAR COOKIE | 7.19 | 1.96 |
| SNICKERDOODLE | 7.19 | 2.1 |
| CHOCOLATE CHIP COOKIE | 8.34 | 1.8 |
| CANDY COOKIE | 8.34 | 1.8 |
| WHITE CHOC. MACADAMIA | 8.34 | 1.8 |
| NUT | | |
| DOUBLE CHOCOLATE | 8.34 | 1.83 |
| CHUNK | | |
| OATMEAL RAISIN COOKIE | 8.35 | 1.65 |
| PEANUT BUTTER COOKIE I | | 2.51 |
| PEANUT BUTTER COOKIE II | 33.15 | 2.22 |
| BROWNIE | 3 | 1.45 |
| MUFFIN BASE | 9.99 | 0.34 |
| CORNMEAL MUFFIN | 5.77 | 0.54 |

A calculate moisture level was determined for each of the respective shelf-stable dough products: Shelf-Stable Sugar Cookie Dough—13.3%; Shelf-Stable Snickerdoodle Dough—13.26%; Shelf-Stable Chocolate Chip Cookie Dough—11.5%; Shelf-Stable Candy Cookie Dough—11.5%; Shelf-Stable White Chocolate Macadamia Nut Cookie Dough—11.2%; Shelf-Stable Double Chocolate Chunk Cookie Dough—10.99%; Shelf-Stable Oatmeal Raisin Cookie Dough—10.96%; Shelf-Stable Peanut Butter Cookie Dough I—8.07%; Shelf-Stable Peanut Butter Cookie Dough II—8.9%; Shelf-Stable Brownie Dough—14.6%; Shelf-Stable Muffin Base—18.7%; and Shelf-Stable Cornmeal Muffin—13.3%

While the invention has been particularly shown and described with reference to preferred embodiments thereof, it will be understood by those skilled in the art that various changes in form and details may be made therein without departing from the spirit and scope of the invention. It is to be understood that even though numerous characteristics and advantages of the present invention have been set forth in the foregoing description, together with details of the structure and function of present invention, the sequence or order of the specific steps, or the actual compositions or materials used may vary. Further more, it will be appreciated that this disclosure is illustrative only and that changes may be made in detail, especially in matters of shape, size, substitution of equivalent ingredients or sequence steps of the invention within the principles of the invention to the full extent indicated by the broad general meaning of the terms in which the appended claims are expressed.

What is claimed is:

1. A shelf-stable, yeastless sweet goods dough composition, comprising:
a) a sufficient amount of flour to provide suitable structure to a finished bakery product that has been created from the shelf-stable sweet goods dough composition; the dough composition including from about 10 to about 50 percent by weight of flour; a portion of the flour being wheat flour and a portion of the flour being flour selected from the group consisting of barley flour, oat flour and a mixture of the same; the flour selected from the group consisting of barley flour, oat flour and a mixture of the same being at least about 0.5 percent by weight of the shelf-stable, yeastless sweet goods dough composition; wherein a ratio of wheat flour to flour selected from the group consisting of barley flour, oat flour and a mixture of the same in the dough composition is from about 1:1 to about 100:1;
b) from about 15 to about 50 percent by weight sweeteners including from about 0 to about 50 percent by weight granulated sugar and from about 2 to about 50 percent by weight liquid sweetener; wherein the liquid sweeteners include at least about 10 percent by weight of moisture;
c) from about 0.5 to about 18 percent by weight eggs;
d) from about 0.2 to about 2.0 percent by weight leavening agent;
e) from about 5 to about 25 percent by weight fats and oils; and
f) from about 0.5 to about 10 percent by weight emulsifying agents; wherein sufficient bound water is contained collectively in the combination of the flour, the sweeteners, the fats and oils and the eggs to provide a moisture content to the shelf-stable, yeastless sweet goods dough composition of from about 5 to about 20 percent by weight.

2. The shelf-stable, yeastless sweet goods dough composition of claim 1, wherein a portion of the flour is barley flour.

3. The shelf-stable, yeastless sweet goods dough composition of claim 1, wherein a portion of the flour is oat flour.

4. The shelf-stable, yeastless sweet goods dough composition of claim 1, wherein a portion of the flour is a mixture of barley flour and oat flour.

5. A shelf-stable, yeastless sweet goods dough composition, comprising:
a) from about 10 to about 50 percent by weight of flour; wherein a portion of the flour is wheat flour and a portion of the flour is flour selected from the group consisting of barley flour, oat flour and a mixture of the same; wherein the flour selected from the group consisting of barley flour, oat flour and a mixture of the same is at least about 0.5 percent by weight of the shelf-stable, yeastless sweet goods dough composition; wherein a ratio of wheat flour to flour selected from the group consisting of barley flour, oat flour and a mixture of the same in the shelf-stable, yeastless sweet goods dough composition is from about 1:1 to about 100:1;
b) from about 5 to about 50 percent of sweetening ingredients; a portion of the sweetening ingredients include from about 15 to about 35 percent moisture;
c) from about 3 to about 12 percent by weight of eggs;
d) from about 5 to about 25 percent by weight of fats and oil;
e) from about 0.2 to about 2.0 percent by weight leavening agent; and
f) from about 0.5 to about 10 percent by weight emulsifying agents; wherein sufficient bound water is contained collectively in the combination of the flour, the sweetening ingredients, the fats and oils and the eggs when added during the mixing process to provide a moisture content to the shelf-stable, yeastless sweet goods dough composition of from about 5 to about 20 percent by weight; sufficient emulsification is provided by the emulsifying agents to prevent the fats and oils from separating from the dough composition during storage at room temperature for at least 90 days and sufficient water scavenging is provided by the flour selected from the group consisting of barley flour, oat flour and a mixture of the same so that baked products made from the shelf-stable, yeastless sweet goods dough composition in a baking process remain desirable even after storing the shelf-stable, yeastless sweet goods dough composition at room temperature in an ambient atmosphere for at least 90 days.

6. The shelf-stable, yeastless sweet goods dough composition of claim 5, wherein a portion of the flour is barley flour.

7. The shelf-stable, yeastless sweet goods dough composition of claim 5, wherein a portion of the flour is oat flour.

8. The shelf-stable, yeastless sweet goods dough composition of claim 5, wherein a portion of the flour is a mixture of barley flour and oat flour.

9. A shelf-stable, yeastless sweet goods dough composition, comprising:
a) a sufficient amount of flour to provide suitable structure to a finished bakery product that has been created from the shelf-stable sweet goods dough composition; the dough composition including from about 10 to about 50 percent by weight of flour; a portion of the flour being wheat flour and a portion of the flour being barley flour, the portion of barley flour being at least about 0.5 percent by weight of the shelf-stable, yeastless sweet goods dough composition; wherein a ratio of wheat flour to barley flour is from about 1:1 to about 100:1;
b) from about 15 to about 50 percent by weight sweeteners including from about 0 to about 50 percent by weight granulated sugar and from about 2 to about 50 percent by weight liquid sweetener; wherein the liquid sweeteners include at least about 10 percent by weight of moisture;
c) from about 0.5 to about 18 percent by weight eggs;
d) from about 0.2 to about 2.0 percent by weight leavening agent;
e) from about 5 to about 25 percent by weight fats and oils; and
f) from about 0.5 to about 10 percent by weight emulsifying agents; wherein sufficient bound water is contained collectively in the combination of the flour, the sweeteners, the fats and oils and the eggs to provide a moisture content to the shelf-stable, yeastless sweet goods dough composition of from about 5 to about 20 percent by weight.

10. A shelf-stable, yeastless sweet goods dough composition, comprising:
a) a sufficient amount of flour to provide suitable structure to a finished bakery product that has been created from the shelf-stable sweet goods dough composition; the dough composition including from about 10 to about 50 percent by weight of flour; a portion of the flour being wheat flour and a portion of the flour being oat flour, the portion of oat flour being at least about 0.5 percent by weight of the shelf-stable, yeastless sweet goods dough composition; wherein a ratio of wheat flour to oat flour is from about 1:1 to about 100:1;
b) from about 15 to about 50 percent by weight sweeteners including from about 0 to about 50 percent by weight granulated sugar and from about 2 to about 50 percent by weight liquid sweetener; wherein the liquid sweeteners include at least about 10 percent by weight of moisture;
c) from about 0.5 to about 18 percent by weight eggs;
d) from about 0.2 to about 2.0 percent by weight leavening agent;
e) from about 5 to about 25 percent by weight fats and oils; and
f) from about 0.5 to about 10 percent by weight emulsifying agents; wherein sufficient bound water is contained collectively in the combination of the flour, the sweeteners, the fats and oils and the eggs to provide a moisture content to the shelf-stable, yeastless sweet goods dough composition of from about 5 to about 20 percent by weight.

11. A shelf-stable, yeastless sweet goods dough composition, comprising:
a) a sufficient amount of flour to provide suitable structure to a finished bakery product that has been created from the shelf-stable sweet goods dough composition; the dough composition including from about 10 to about 50 percent by weight of flour; a portion of the flour being wheat flour;
b) from about 15 to about 50 percent by weight sweeteners including from about 0 to about 50 percent by weight granulated sugar and from about 2 to about 50 percent by weight liquid sweetener; wherein the liquid sweeteners include at least about 10 percent by weight of moisture;
c) from about 0.5 to about 18 percent by weight eggs;
d) from about 0.2 to about 2.0 percent by weight leavening agent;
e) from about 5 to about 25 percent by weight fats and oils;
f) from about 0.01 to about 2.5 percent by beta glucans; and
g) from about 0.5 to about 10 percent by weight emulsifying agents; wherein sufficient bound water is contained collectively in the combination of the flour, the sweeteners, the fats and oils and the eggs to provide a moisture content to the shelf-stable, yeastless sweet goods dough composition of from about 5 to about 20 percent by weight.

12. A shelf-stable, yeastless sweet goods dough composition, comprising:
a) from about 10 to about 50 percent by weight of flour; wherein a portion of the flour is wheat flour;
b) from about 5 to about 50 percent of sweetening ingredients; a portion of the sweetening ingredients include from about 15 to about 35 percent moisture;
c) from about 3 to about 12 percent by weight of eggs;
d) from about 5 to about 25 percent by weight of fats and oil;
e) from about 0.2 to about 2.0 percent by weight leavening agent;
f) from about 0.01 to about 2.5 percent by beta glucans; and
g) from about 0.5 to about 10 percent by weight emulsifying agents; wherein sufficient bound water is contained collectively in the combination of the flour, the sweetening ingredients, the fats and oils and the eggs when added during the mixing process to provide a moisture content to the shelf-stable, yeastless sweet goods dough composition of from about 5 to about 20 percent by weight; sufficient emulsification is provided by the emulsifying agents to prevent the fats and oils from separating from the dough composition during storage at room temperature for at least 90 days and sufficient water scavenging is provided by the beta glucans so that baked products made from the shelf-stable, yeastless sweet goods dough composition in a baking process remain desirable even after storing the shelf-stable, yeastless sweet goods dough composition at room temperature in an ambient atmosphere for at least 90 days.
